(19) United States
(12) Patent Application Publication
(10) Pub. No.: US 2016/0358108 A1
(43) Pub. Date: Dec. 8, 2016

(54) AUTOMATED DETERMINATION AND ALLOCATION OF USER SOURCED PARKING SPACE

(71) Applicants: Alex Sadovsky, Vaughan (CA); Alex Levin, Kiryat Yam (IL)

(72) Inventors: Alex Sadovsky, Vaughan (CA); Alex Levin, Kiryat Yam (IL)

(21) Appl. No.: 15/012,161

(22) Filed: Feb. 1, 2016

Related U.S. Application Data
(60) Provisional application No. 62/110,598, filed on Feb. 1, 2015.

(51) Int. Cl. G06Q 10/02

(52) U.S. Cl. CPC G06Q 10/02

(57) ABSTRACT

The disclosure is directed to systems and methods for providing location and time based parking space. Specifically, the disclosure is directed to systems and methods for providing a user-coordinated, temporospatial-specific parking space.

### BACKGROUND

The present disclosure relates to systems and methods for providing location and time based parking space. Specifically, the disclosure relates to systems and methods for providing a user-coordinated, temporospatial-specific parking space.

Conventional methods for parking reservation systems, such as parking lots, allow owners to post parking spaces offers that they own. Typically, the system can facilitate parking usage, whereby during operation, the system receives a parking reservation request from a user and obtains a set of available parking spaces based on the parking reservation request. Next, the system provides the available parking spaces to the user and obtains, from the user, a selection of a parking space from the available parking spaces. Finally, the system reserves the parking space for the user. Additionally, the reservation system can also validate the user with at least one of a phone number, IMEI, a login, a vehicle license plate number, a credit card number, an identification card, and a vehicle transponder.

One of disadvantages of living in urban area is the lack of readily available parking spaces. To overcome the scarcity of parking space, a parking space that becomes vacant when an occupant leaves home or office can be used. Due to the pent-up demand, the owner of the personal (or commercial) parking space might want to rent the personal (or commercial) parking space for a desired time period. Accordingly, what is needed is an improved system and method for addressing such issues.

These and other aspects are addressed by the following systems and methods for providing selectable, temporospatial-specific parking space.

### SUMMARY

Disclosed, in various embodiments, are systems and methods for providing selectable, temporospatial-specific parking space.

In an embodiment, provided herein is a system for automated parking allocation and reservation comprising: a plurality of driver client devices in communication with a communication network; a plurality of host client devices in communication with the communication network; a plurality of driver client databases in communication with the backend management module; a plurality of host client databases in communication with the backend management module; and a backend management module comprising a processor in communication with a non-volatile memory having a processor-readable medium thereon with a set of executable instruction configured to: receive a parking space search query from at least one of the driver client devices; identify host client devices having a personal or a commercial parking space comprising a sensor array configured to provide information about vacancy of the parking space; connect at least one driver client device with a host client device; and receiving information from the sensor array indicating vacancy of the parking space.

In another embodiment, provided herein is a method for providing a user selected parking space, implementable in a system comprising: a plurality of driver client devices in communication with a communication network; a plurality of host client devices in communication with the communication network; a plurality of driver client databases in communication with the backend management module; a plurality of host client databases in communication with the backend management module; and a backend management module comprising a processor in communication with a non-volatile memory having a processor-readable medium thereon with a set of executable instruction configured to: receive a parking space search query from at least one of the driver client devices; identify host client devices having a personal or a commercial parking space comprising a sensor array configured to provide information about vacancy of the parking space; connect at least one driver client device with a host client device; and receiving information from the sensor array indicating vacancy of the parking space, the method comprising the user, using the driver client device, communicating with the backend management module, selecting a preferred parking location; the backend management module, communicating with the plurality of sensor arrays, each sensor array associated with a unique parking space and the host client device, identifying a vacant parking space closest to the user-selected location; the backend server connecting the driver client device with the host client device associated with the vacant parking space closest to the user selected parking location; and the host client device providing the driver client device with a unique identifier for the identified vacant parking space.

These and other features of the systems and methods for providing user selectable, temporospatial-specific parking space will become apparent from the following detailed description when read in conjunction with the drawings, which are exemplary, not limiting.

### BRIEF DESCRIPTION OF THE FIGURES

For a better understanding of the systems and methods for providing user selectable, temporospatial-specific parking space, with regard to the embodiments thereof, reference is made to the accompanying drawings, in which:

FIG. 1, illustrates an embodiment of the parking system and its components' interrelationship;

FIG. 2 illustrates another embodiment of the systems enabling embodiments of the methods described and claimed;

FIG. 3, illustrates the communication between the sensor array and the host client device;

FIG. 4, illustrates an embodiment of the flow of activities by various system's component according to certain method embodiments; and

FIG. 5, illustrates another aspect of the methods provided herein.

The figures depict various embodiments of the present disclosure for purposes of illustration only. One skilled in the art will readily recognize from the following discussion that alternative embodiments of the structures and methods illustrated herein may be employed without departing from the principles of the invention described herein.

### DESCRIPTION

Provided herein are embodiments of systems and methods for providing user selectable, temporospatial-specific parking space.

Provided herein is a computerized system that can be implemented on various client devices, for example; mobile, tablet and a computer that can facilitate peer-to-peer (P2P) and or renter (individual and/or business) and parking owners (private, business and/or municipal/public services such as parking lots) to list, advertise, promote, book/reserve, check availability, list and lock pricing, details of use—terms and conditions per location, reviews by renters and parking owners, find parking spots and location (GPS and other systems location based services) on interactive map and or listing, payment exchange between renters and parking owners, social media integration, among others.

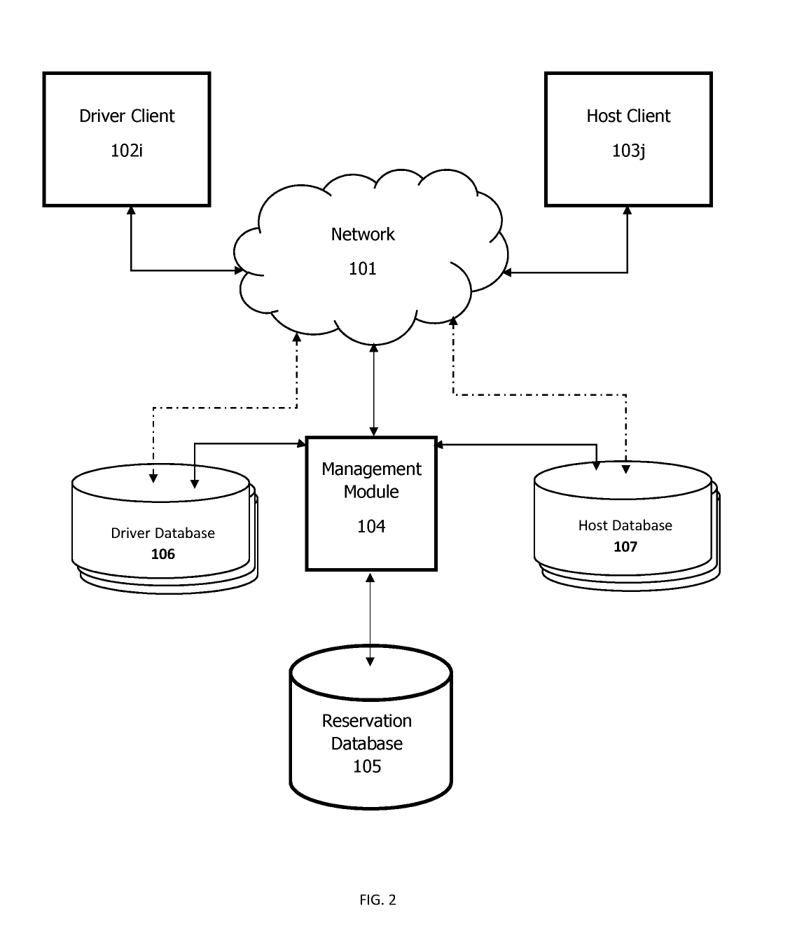

In an embodiment, the computerized system and methods provided, can enable parking owners such as private driveways, underground spaces, municipal or public services parking lots, street parking spaces or commercially used parking spots (parking lots), or, in another example, businesses having plurality of parking spots for employees on off hours and weekends, to list a parking spot(s) for rent/lease/use with description and period of time specified by the owners/lessor. These can be done on hourly, daily, weekly, monthly and or long term basis, with associated terms and conditions, pricing, and features. The system can also allow owners/lessors to promote their space(s) with advertisement services (part of algorithm logic) and facilities with full payment transaction for the parking space as agreed in advance with the lessee as part of the terms and conditions. Each parking owner (host client) can have its own account and database, (see e.g., FIG. 2) and login to list their parking space(s) they offer for rent/lease for third party (Driver) use, set pricing, as well as collect revenue and negotiate/finalize the transaction (lessee/lessor agreement) along with payment. Additionally, the system can be configured to allow lessors to receive and collect funds in various currencies and transfer the accumulated funds from the system to their financial institution such as bank/PayPal or other suitable account.

In an embodiment, Parking renters/lessee (in other words, drivers) access the system via driver client devices, for example; mobile devices, tablet, vehicle manufacturer-installed info-system and web to search for available spaces based on their preferred location specified in the search by address (full or partial such as city, postal code) and or landmark/attraction and/or current GPS location with a specified radius distance from current location (defined in miles, kilometers or time of driving) for available parking spaces. Renters (drivers) can search for open parking spaces on an interactive live map that displays results with additional information and details such as, for example, price, users rating and/or additional services as selected by input of options into the system. The results of the search allow renters to browse availability, read details and reviews and reserve and finalize the rent/lease a space of their choice with the lessor.

The search results obtained using the methods described, implementable in the systems provided, can be sorted as desired with option including but not limited to: estimated arrival time (ETA) to space location (from current GPS location with integrated traffic from, for example, GOOGLE Maps or similar service provider), reviews and score from previous transaction with the same parking owner (including neighborhood safety score and/or user review and/or additional services), preferred time availability, location, travel distance to parking space location, price, payment options, preferred spot option such as parking for expectant mothers/handicapped drivers/close to exit spot and more.

The renter can pay for the parking space through the platform and can receive a message, such as for example, an e-mail and/or SMS confirmation of time and details of the agreement, as well as in other circumstances, other unique identifier for the space and the host. In order for the aforementioned transaction to take place, the renter (or driver client device) has to login into the system with their user information (account has to be created with all required details such as, personal information, vehicle information, credit card information and/or location preferences, among others, and/or provide authentication), which can be updated at any time and stored securely in the system in a Driver client database (see e.g., FIG. 2).

Accordingly and in an embodiment, provided herein is a system for automated parking allocation and reservation comprising: a plurality of driver client devices in communication with a communication network; a plurality of host client devices in communication with the communication network; a plurality of driver client databases in communication with the backend management module; a plurality of host client databases in communication with the backend management module; and a backend management module comprising a processor in communication with a non-volatile memory having a processor-readable medium thereon with a set of executable instruction configured to: receive a parking space search query from at least one of the driver client devices; identify host client devices having a personal or a commercial parking space comprising a sensor array configured to provide information about vacancy of the parking space; connect at least one driver client device with a host client device; and receiving information from the sensor array indicating vacancy of the parking space. Additionally, the system may employ enforcement module, providing for the backend management module verifying the fulfillment of an agreement between the parking spot owner and renter and sending an alarm to parking manager and/or enforcer terminal, the alarm including information about parking lot, spot and the nature of violation of the agreement.

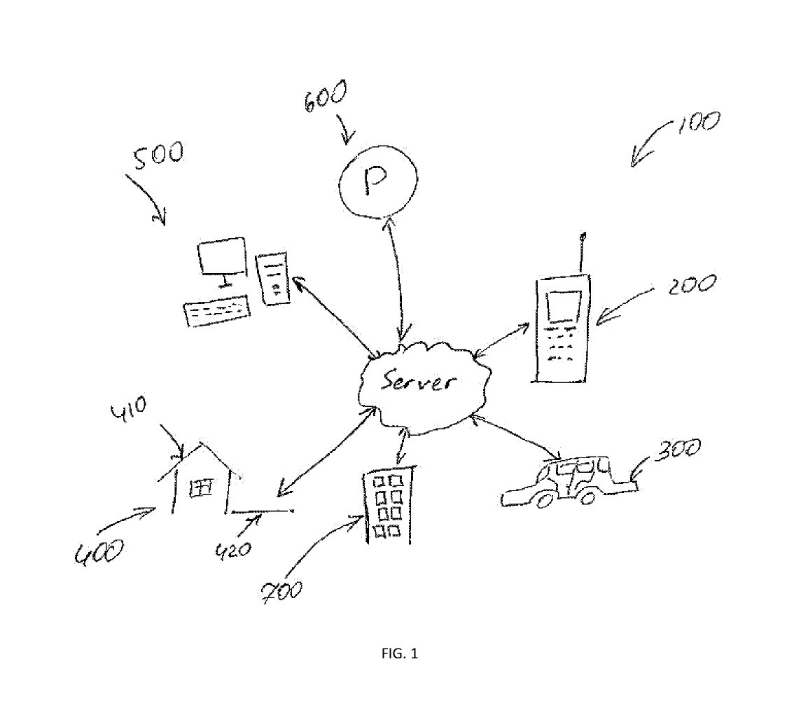

As illustrated in FIG. 1, system 100 can have database 105 that captures and stores all the transactions and can provide both host and driver ranking, based on a predetermined algorithm. System 100 can further comprise backend management module 104 used in an embodiment, for example, to promote lessors (hosts) according to peer reviews, availability, and price among others. System 100 can rank and score renters/lessee and lessors based on, in an example, successful previous transaction where their individual score is displayed for both parties prior to finalizing transaction. The search results, as inputted with option by renter, can be sorted by, for example: time of arrival to selected parking space, transaction history of lessor (score), and reviews, distance radius, time and availability, pricing, payment options, safety score (as provided by previous renters in reviews) etc.

Furthermore, system 100 can be integrated with GOOGLE™ Maps or similar services for traffic updates, map services and location services (such as GPS). In addition, system 100 can be integrated with major social media platforms including but not limited to (FACEBOOK™, TWITTER™, GOOGLE+™, LINKEDIN™, PINTREST™, and others) enabling lessors to post parking spots, reviews and other information. Moreover, system 100 can be configured to work with Interac, PayPal and other payment systems and facilitate payment with common carrier credit card issuers such as, for example, VISA™, MASTERCARD™, AMEX™ and DISCOVER™.

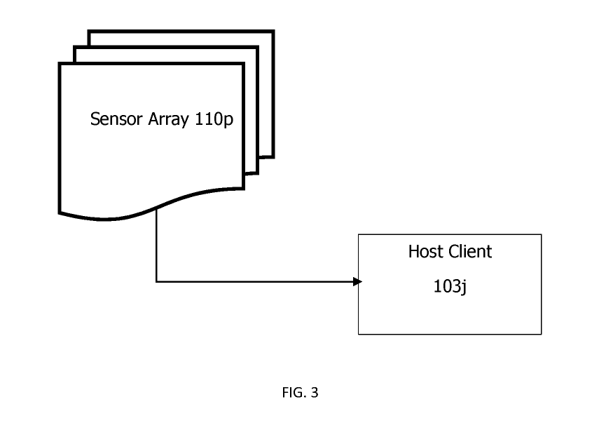

In an embodiment, the sensor array (see e.g., FIG. 3), used in the methods for providing user selectable, temporospatial-specific parking space, implementable in the systems described and claimed can comprise: a (e.g., CCD, CMOS) camera, an infrared (IR) sensor, a radar, an induction loop, a pressure sensor, a proximity sensor, a load cell, an ultrasound sensor, or a combination thereof in communication with a transceiver. The sensor array can be housed in a single housing or be distributed at several locations in or around the parking space. When installed on ground, the sensor can be flush to the ground. In general, the sensor array is configured to provide real-time information on the status of the parking space and/or the smartphone of the occupant of the spot. In other words, provide information authenticating the parked vehicle and be connected to the backend management server 104 and with the host-client device 103j, through network, by, in an embodiment, internet-of-things (TOT) protocols. In an embodiment, the term “sensor array” as used herein encompasses an array of sensors arranged on a substrate (a housing). The substrate can be disposed on a wall, floor column, beacon, ceiling or other appropriate structure associated with a single parking space. Likewise, “sensor array” 110ₚ may comprise an M×N array of sensors; wherein both M and N are integer numbers equal to or greater than one. Thus, the scope of the term “sensor array” is not intended to exclude devices having only one sensor.

Further, in an embodiment, single parking lot may include numerous sensor arrays.

Further, location data for (plurality of) driver client device(s) 102ᵢ can be gathered in real-time using Geo-positioning systems (for example, GPS) located on the driver client device, or for each of the (plurality of) driver client device(s) 102ᵢ that may be any type of mobile electronic device having a display and wireless communication capability. These can be, for example, cellular telephone handsets, personal digital assistants (PDAs), tablet computers, phablets and handheld gaming devices and the like. The location determination can be, for example when the vehicle is within a range of between about lm to about 500 m from a location determining device, forming a part of the sensor array, for example, a short range communication device. Short-range communications can be, for example, Bluetooth®. (“BLUETOOTH® is a registered trademark of Bluetooth SIG”), WiFi® (“WI-FI® is a registered trademark of the Wi-fi alliance”), UWB, Zigbee® (“Zigbee® is a registered trademark of Zigbee alliance), whispering optical display, 3G and 4G LTE other augmented sensor networks etc. The display devices on (plurality of) driver client device(s) 102ᵢ can communicate with main application server or backend management module 104 and each other 110ₚ through predetermined communications channels.

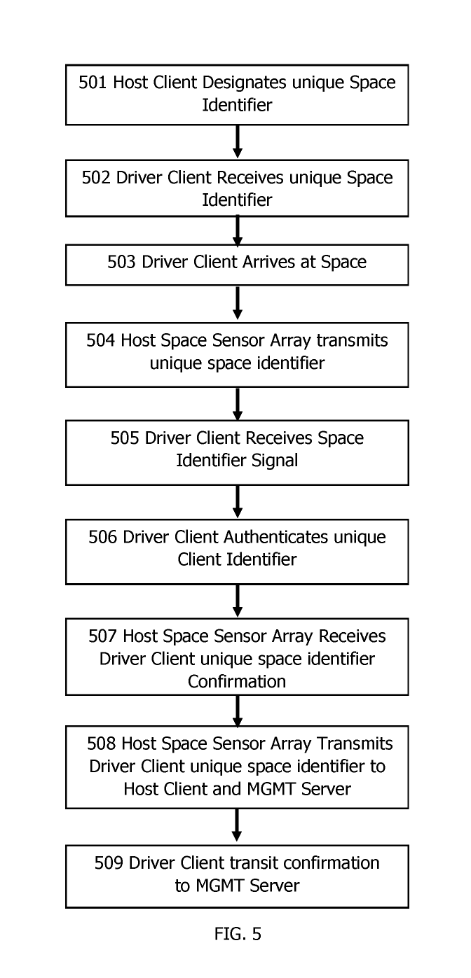

The network used in the methods for providing user selectable, temporospatial-specific parking space, implementable in the systems described and claimed can be, for example, a cellular network, a local area network, a wide area network, a wireless network or a network comprising one or more of the foregoing. Further, systems 100 and methods can be adapted to: establish a dedicated communication network, (or use existing networks) robust enough to endure a large number of dislocated devices (e.g., cellular telephone handsets or smartphones, personal digital assistants (PDAs), tablet computers, phablets, laptops, handheld gaming devices and the like) without overloading the network. The systems can also be adapted and configured for generating communication algorithm to send data packets (e.g., proof of driver identity, token to activate various actuators in the parking space) to the driver/host (input) devices in a fast and efficient manner. Also, the systems provided herein, used in conjunction with the methods described herein, can be configured to create a positioning system that will temporospatially pinpoint the dislocated input devices and/or vehicle(s) (see e.g., FIG. 5).

The communication network channel can be the conduit where all the information can be transmitted from an application server(s) to the input devices. Typical open communication network grid in a public area can often be quite congested. For example, using a dedicated protocol of communication to avoid data overload can effectively and efficiently manage communication between the various components of the system as illustrated in FIGS. 1 and 2.

In an embodiment, using a mapping application residing on the driver client device, end users located in the vicinity of a sensor array associated with a single parking space, can log on to the management server (or backend management module) and synchronize with the system. The term “synchronized” refer for example, to the transfer of timing information and files or content so that driver client devices (and/or vehicles) are “synchronized” with respect to the information on the application server.

For example, global positioning (or geopositioning) system (GPS) refers to a space-based global navigation satellite system that can provide location and time (temporospatial) information at practically all times and for practically anywhere on the Earth when and where there is an unobstructed line of sight to four or more GPS satellites. Typically, a GPS receiver used in the systems and methods provided as part of the driver client device herein can calculate a position of the receiver by precisely timing the signals sent by the GPS satellites. Each satellite can then continually transmit messages that include such information as the time the message was transmitted, the precise orbital information for the satellite, and the general system health and rough orbits of all GPS satellites. The GPS receiver located for example on the application server, can then utilize the messages it receives to determine a transit time of each message independent of the end user and compute the distance to each satellite. These distances along with the satellites' locations are used to compute the position of the receiver and transmitter.

Additionally, communication between the application server (interchangeable with backend management module) and host client device 103ⱼ can be secured wired or wireless communication. The secured communication of the data transferred between the application server and host client device 103ⱼ can utilize cryptography keys to encrypt and decrypt secured data. The keys can be established within the secured communications session. Alternatively, the application server and host client device(s) 103ⱼ can form a group of processor-based nodes (e.g., servers and/or other resources) that act like a single system. In other words, the clustering can communicatively connect two or more devices together in such a way that they behave like a single device. Clustering can be used for parallel processing, load balancing, and/or fault tolerance (or “high availability”), as examples. Each node of a cluster may be referred to as a “member” of that cluster. In an embodiment a member can be a business with a plurality of parking spaces, each with its p^{th} sensor array 110p, associated with a given parking space and the host client can manage and allocate each parking space to a driver client (or user)

The terms “user”, “customer”, “consumer” and formatives thereof as utilized herein refer to any party desiring to initiate interaction with an information/support service accessible by the methods and systems described herein.

Additionally, a local area network (LAN) may also be incorporated into the system. The local area network may be in communication with the main application server(s) and host client device 103ⱼ (see e.g., FIG. 2). The local area network may be a wireless local area network. The local area network may provide internet access on subscription-based usage or without subscription.

In an embodiment, driver client device 102ᵢ can include a controller comprising a central processing unit (CPU) that is microprocessor-based. The controller can perform various functions including, for example, establish communication with the backend management module; provide preferred parking location; establish communication with the host client device; receive unique parking space identifier; and communicate to the backend management module occupying and vacating the parking space. Additionally, in an embodiment the controller can send alerts and//or alarms tp parking manager/enforcer terminal. The user interface used in the systems and methods described herein to facilitate the communication, may be one or a combination of different types of user interfaces depending upon the device. Many tablet computers include push-buttons or touch screens or both, keyboards, styluses and other types of driver client devices. The user interface can be used to provide various driver clients and responses to elements displayed on the driver client device. When the user interface is a touch screen or touch display, the screen display and the user interface may be one in the same. More than one user interface may be incorporated into the driver client device.

A memory component can also be in communication with the controller. The memory component may include different types of memory that store different types of data. The memory component may store operating software for the device, operating data, user settings, documents, and applications. The applications may perform various functions, including an application for communicating with the main application server and sensor arrays 110p, illustrated in FIG. 3 and obtaining data from host client device 103ⱼ and the application server. The application may allow the driver client device(s) to communicate directly with the application server.

A web interface may also be used for communicating with the application server and/or host client device 103ⱼ. The web interface may allow a connection to the local area network (e.g., LAN or WiLAN). The web interface may also allow communication through a wireless network such as a local area network, wide area network (WAN) or a dedicated mobile or cellular network.

An interface component of the portal (in other words, the home page of the web interface) accessed when using the systems and methods described, can be configured to connect to and retrieve requested data from a gateway application server (in other words, the database main server) See e.g., FIGS. 1, 2 and 4.

The term “application server” or “gateway server” refers to a back-end hardware and software product that is used to manage content. Further, the term “dedicated interface” refers to information or content items displayed within a region of a portal web site or a specific application used for a specific event. For example, a dedicated interface can be a component of a portal web site and is a smaller web application that runs on a portal server (e.g., a portlet). The interaction of the application or gateway server with insurance provider is illustrated for example in FIG. 7.

End-user dedicated and/or customized interfaces can be applications that provide the proper queries to access relevant data, provide access for uploading product or service data, upon obtaining permission in the form of, for example, a code or a token, accessing other user-specific data server(s), e.g., the application server and the like. (see e.g., FIG. 1, 2)

The methods described herein can be achieved through processing whereby a browser can send a Hypertext Transfer Protocol (“HTTP”) request to a portal engine. (Portal implementations may be structured with functionally distinct modules referred to generally as an engine and a dedicated interface container, where the engine is responsible for content and the container is responsible for dedicated interface lifecycle functions that include dispatch of the action and render methods. The term “portal engine”, however, is used as a reference to a combination of these two functional modules.).

In addition, routines such as allowing access to the various database(s), or among user (e.g., host 103ⱼ)-specific data servers can be restricted to back-end (main) application server and systems.

Similar to the driver client device, the host client device can also include a controller comprising a central processing unit (CPU) that is microprocessor-based. The controller can perform various functions including, for example, establish communication with the backend management module; establish communication with the sensor array; authenticate the driver client device; provide the driver client device with the unique identifier for the parking space; via communication with the sensor array, validate and communicate to the backend management module occupying and vacating the parking space.

Likewise, the step of temporospatially locating each of plurality of driver client device(s) 102ᵢ and/or the vehicles within a discrete area can comprise the step of triangulating each device or vehicle using WiFi, Bluetooth, GPS, 3G, 4G, ZigBee, Near-Field Communication or a combination comprising the aforementioned platforms.

The term “triangulating” is used here-at in a loose sense for lack of better terminology. It does not necessarily have to imply collecting data from three linear vectors pointing into a hierarchical space and to a subregion or node located at an intersection point of the three linear vectors. Using built-in transceivers in the driver client device(s), each of the driver client device(s) transceiver can record the beacons' IDs, and determines the received signal strengths, of the beacon transmissions it detects. The received signal strength can establish a maximum plausible distance between the beacon and the driver client device(s) transceiver. Using the networked application, the transceivers forward some or all of this information to the main content-management server or other processing node (in communication with the application server, e.g., the insurance provider's). The processing node (or main server) can then use this information, together with information about expected received signal strengths in specific areas, to predict the current location (i.e. temporospatial location) of each transceiver ergo each driver client device(s). Other methods can use triangulation using similar methods but using 3G or 4G (or other) with a plurality (e.g., more than 3) cell towers distributed in the volume. Likewise, The term “communication path” refers to a communication format that has multiple channels. For example, contemplated communication paths include radio frequency bands, including NOAA frequency band, EAS frequency band, various UHF and/or VHF frequency bands, microwave and infrared frequency bands, frequency bands used for cellular communication, cable and/or satellite TV transmission systems, optical network systems, and/or high-speed digital data transmission systems. The term “channel” can refer to a specific modality within the communication path. For example, where the communication path is cellular communication (e.g., 824-849 MHz, 869-894 MHz, or 1850-1990 MHz), the channel may be a single frequency, or a spectrum of multiple frequencies (e.g., CDMA signal) within that communication path. Likewise, where the communication path is a fiber optic cable system, channels will correspond to high-speed (e.g., >1.0 Mb/s) digital data transmission system, a channel may be a network address.

In an embodiment, the system for implementing the methods described herein can further comprise a load balancer in communication with the plurality of wide area network servers, web data servers, node data servers and the like; and the plurality of driver client device(s). The load balancer can communicate as described herein over a large multi-node network, such as the dedicated WiLAN. The systems described herein, for implementing the methods provided herein, can further comprise an administrative client device and a business client device in communication with the main gateway application server. The term “server” refers for example to the process that provides the service, or the host computer on which the process operates. Similarly, the term “client”, or “client device” refers in another embodiment to the process or device that makes the request, or the host computer/device on which the process operates. As used herein, the terms “client” and “server” can refer to the processes, rather than the host computers, unless otherwise clear from the context. In addition, the process performed by a server can be broken up to run as multiple processes on multiple hosts for reasons that include reliability, scalability, security and redundancy, among others.

Accordingly, provided herein is a non-transitory computer or processor readable storage medium having stored thereon processor-executable software instructions configured to cause a processor to perform the operations associated with the method for purchasing a product or a service using driver client device(s) as described herein. These instructions can be, for example, to establish communication with the backend management module; provide preferred parking location; establish communication with the host client device; receive unique parking space identifier; and communicate to the backend management module occupying and vacating the parking space.

In addition, provided herein is a non-transitory processor readable storage medium having stored thereon processor-executable software instructions configured to cause a processor to perform operations associated with the method providing selectable, temporospatial-specific parking space as described herein.

The term “processor-readable medium” as used herein refers to any medium that participates in providing information to the processor, including instructions for execution. Such a medium may take many forms, including, but not limited to computer-readable storage medium (e.g., non-volatile media), and transmission media. Non-transitory media, such as non-volatile media, include, for example, optical or magnetic disks. Volatile media, when used in conjunction with the non-volatile media, can be, for example, dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

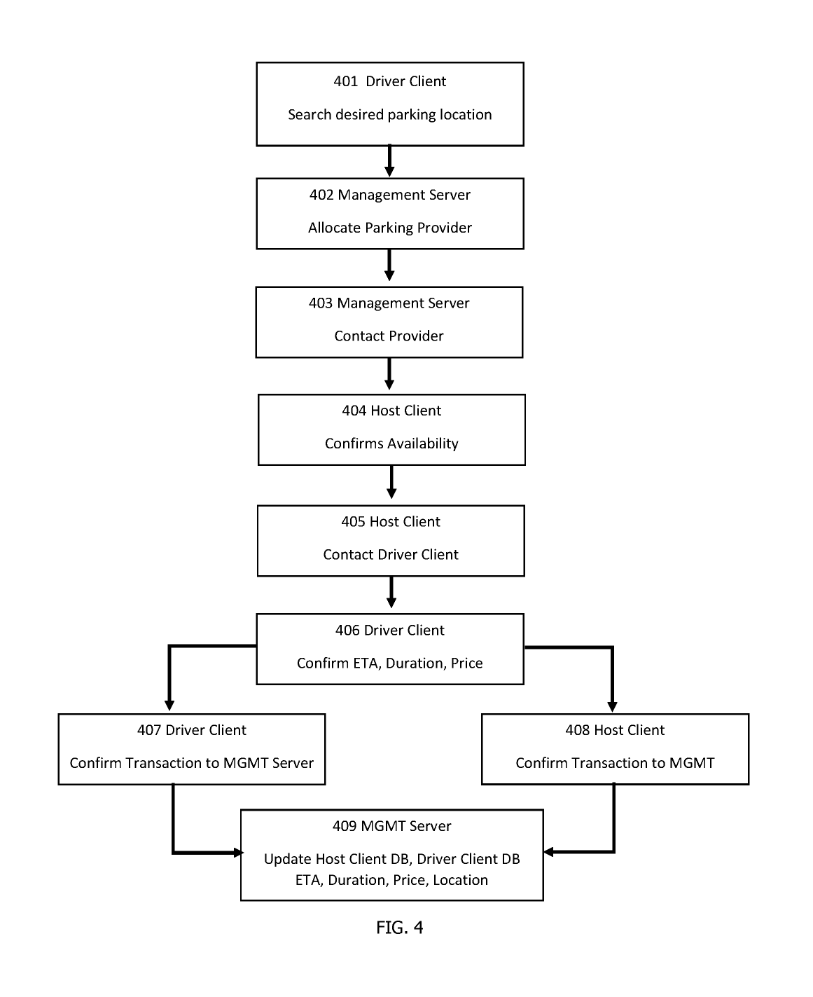

As illustrated in FIGS. 4 and 5 and in an embodiment, provided herein is a method for providing a user selected parking space, implementable in system 100 (FIG. 1) comprising: plurality of driver client devices 102ᵢ in communication with a communication network 101; plurality of host client devices 103ⱼ in communication with communication network 101; plurality of driver client databases 106 in communication with the backend management module 104; plurality of host client databases 107 in communication with backend management module 104; and backend management module 104 comprising a processor in communication with a non-volatile memory having a processor-readable medium thereon with a set of executable instruction configured to: receive a parking space search query 401 from at least one i^{th} of driver client devices 102ᵢ; identify host client devices 103ⱼ having a personal or a commercial parking space 402 comprising sensor array 110ₚ configured to provide information about vacancy of the parking space; connect at least one driver client device 102ᵢ with host client device 103ⱼ; 403, 404 and receiving information from sensor array 110ₚ indicating vacancy of the parking space, the method comprising the user, using driver client device 102₁, communicating 401 with backend management module 104, selecting a preferred parking location; backend management module 104, communicating with plurality of sensor arrays 110ₚ, each p^{th} sensor array 110ₚ associated with a unique parking space and host client device 103ⱼ, identifying 402 a vacant parking space closest to the user-selected location; backend module 104 connecting 403, 404 driver client device 102₁ with host client device 103ⱼ associated with the vacant parking space closest to the user selected parking location; and host client device 103ⱼ providing 405 driver client device 102ᵢ with a unique identifier 501 for the identified vacant parking space.

In an embodiment, the unique identifier used in the methods for providing user selectable, temporospatial-specific parking space, implementable in the systems described and claimed can comprise a location identifier for the parking space using for example, the integrated mapping application and in addition, means for authenticating the driver client device. In addition to the token generated as described above, the means for authenticating driver client device 102ᵢ comprise a personal identification number (PIN), a RFID identifier, a QR code, a barcode or a combination comprising one or more of the foregoing.

Accordingly and in another embodiment, the methods described herein, implementable in the (computer) systems described, can further comprise: following receipt by driver client device 102ᵢ of the unique identifier of the parking space 502 and upon arriving at the user selected parking location 503, driver client device 102ᵢ communicating 504, 505 with sensor array 110ₚ associated with the user selected parking space to authenticate 506 driver client device 102ᵢ. Upon authentication, 507 driver client device 102ᵢ transmitting 509 to host client device 103ⱼ and backend management module 104 occupying the user-selected parking space. Sensor array 110ₚ, using the means for authenticating the driver client device, informing 508 host client device 103ⱼ and backend management module 104 of driver client device 102ᵢ location and non-vacancy of the parking space associated with the sensor array. Upon receiving the update from both driver client device 102ᵢ and sensor array 110p associated with the parking space and/or host client device 103ⱼ, backend management module 104 can be configured to update 409 (see e.g., FIG. 4) driver client database 106 (see e.g., FIG. 1) and host client database 107 of the location of driver client device 102ᵢ, the occupancy status of the parking space and the expected occupation duration.

Alternatively or in addition, the step of backend management module 104, communicating with plurality of sensor arrays 110ₚ, each p^{th} sensor array associated with a unique parking space and j^{th} host client device 103ⱼ, identifying a vacant parking space closest to the user-selected location, can be preceded by a step of backend management module 104 retrieving all occupied parking spaces in the vicinity of the user selected parking space from host client database 107 and/or the driver client database 106.

Also, provided herein is a non-transitory computer readable storage medium having stored thereon processor-executable software instructions configured to cause a processor to perform the operations associated with the method of any of the steps described in the methods described hereinabove.

Furthermore, the terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the driver client device(s) includes one or more dislocated device).

Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “plurality”, as used herein, is defined as two or as more than two. The term “another”, as used herein, is defined as at least a second or more. The terms “including” and/or “having”, as used herein, are defined as comprising (i.e., open language).

The term “communication” and its derivatives (e.g., “in communication”) may refer to a shared bus configured to allow communication between two or more devices, or to a point to point communication link configured to allow communication between only two (device) points. Likewise, the term “operatively coupled” or “operably coupled” refers to a connection between devices or portions thereof that enables operation in accordance with the present system. For example, an operative coupling may include one or more of a wired connection and/or a wireless connection between two or more devices that enables a one and/or two-way communication path between the devices or portions thereof. In addition, an operable coupling may include a communication path through a wired and/or wireless network, such as a connection utilizing the Internet. The term contact center is utilized herein to describe a support/service center and as such, may be a contact center, call center, etc.

Accordingly, provided herein is a system for automated parking allocation and reservation comprising: a plurality of driver client devices in communication with a communication network; a plurality of host client devices in communication with the communication network; a plurality of driver client databases in communication with the backend management module; a plurality of host client databases in communication with the backend management module; and a backend management module comprising a processor in communication with a non-volatile memory having a processor-readable medium thereon with a set of executable instruction configured to: receive a parking space search query from at least one of the driver client devices; identify host client devices having a personal or a commercial parking space comprising a sensor array configured to provide information about vacancy of the parking space; connect at least one driver client device with a host client device; and receiving information from the sensor array indicating vacancy of the parking space, wherein (i) the sensor array comprises: an infrared (IR) sensor, a radar, an induction loop, a pressure sensor, a proximity sensor, a load cell, an ultrasound sensor, or a combination thereof in communication with a transceiver, (ii) configured to communicate with the driver client device and the host client device, wherein (iii) the network is a cellular network, a local area network, a wide area network, a wireless network or a network comprising one or more of the foregoing, wherein (iv) the driver client device comprises a transceiver and a processor in communication with a non-volatile memory having a processor-readable medium thereon with a set of executable instruction configured to: establish communication with the backend management module; provide preferred parking location; establish communication with the host client device; receive unique parking space identifier; and communicate to the backend management module occupying and vacating the parking space, and wherein (v) the host client device comprises a transceiver and a processor in communication with a non-volatile memory having a processor-readable medium thereon with a set of executable instruction configured to: establish communication with the backend management module; establish communication with the sensor array; authenticate the driver client device; provide the driver client device with the unique identifier for the parking space; and via communication with the sensor array, validate and communicate to the backend management module occupying and vacating the parking space.

In another embodiment, provided herein is a method for providing a user selected parking space, implementable in a system comprising: a plurality of driver client devices in communication with a communication network; a plurality of host client devices in communication with the communication network; a plurality of driver client databases in communication with the backend management module; a plurality of host client databases in communication with the backend management module; and a backend management module comprising a processor in communication with a non-volatile memory having a processor-readable medium thereon with a set of executable instruction configured to: receive a parking space search query from at least one of the driver client devices; identify host client devices having a personal or a commercial parking space comprising a sensor array configured to provide information about vacancy of the parking space; connect at least one driver client device with a host client device; and receiving information from the sensor array indicating vacancy of the parking space, the method comprising the user, using the driver client device, communicating with the backend management module, selecting a preferred parking location; the backend management module, communicating with the plurality of sensor arrays, each sensor array associated with a unique parking space and the host client device, identifying a vacant parking space closest to the user-selected location; the backend module connecting the driver client device with the host client device associated with the vacant parking space closest to the user selected parking location; and the host client device providing the driver client device with a unique identifier for the identified vacant parking space, wherein (vi) the unique identifier comprises a location and means for authenticating the driver client device, (vii) the means for authenticating the driver client device comprise a personal identification number (PIN), a RFID identifier, a QR code, a barcode or a combination comprising one or more of the foregoing, wherein (viii) the driver client device comprises a transceiver and a processor in communication with a non-volatile memory having a processor-readable medium thereon with a set of executable instruction configured to: establish communication with the backend management module; provide preferred parking location; establish communication with the host client device; receive unique parking space identifier; and communicate to the backend management module occupying and vacating the parking space, (ix) the host client device comprises a transceiver and a processor in communication with a non-volatile memory having a processor-readable medium thereon with a set of executable instruction configured to: establish communication with the backend management module; establish communication with the sensor array; authenticate the driver client device; provide the driver client device with the unique identifier for the parking space; and via communication with the sensor array, validate and communicate to the backend management module occupying and vacating the parking space, further comprising (x) upon arriving at the user selected parking location, the driver client device communicating with the sensor array associated with the user selected parking space to authenticate the driver client device; the driver client device transmitting to the host client device and the backend management module occupying the user selected parking space; the sensor array, using the means for authenticating the driver client device, informing the host client device and the backend management module of the driver client device location and non-vacancy of the parking space associated with the sensor array, (xi) further comprising the backend management server updating the driver client database and the host client database of the location of the driver client device, the occupancy status of the parking space and the expected occupation duration, wherein (xii) wherein the step of the backend management module, communicating with the plurality of sensor arrays, each sensor array associated with a unique parking space and the host client device, identifying a vacant parking space closest to the user-selected location, is preceded by a step of the backend management module retrieving all occupied parking spaces in the vicinity of the user selected parking space from the host client database and/or the driver client database, (xiii) the sensor array comprises: an infrared (IR) sensor, a radar, an induction loop, a pressure sensor, a proximity sensor, a load cell, an ultrasound sensor, or a combination thereof in communication with a transceiver and wherein (xiv) wherein the network is a cellular network, a local area network, a wide area network, a wireless network or a network comprising one or more of the foregoing.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

1. A system for automated parking allocation and reservation comprising:
a. a plurality of driver client devices in communication with a communication network;
b. a plurality of host client devices in communication with the communication network;
c. a plurality of driver client databases in communication with the backend management module;
d. a plurality of host client databases in communication with the backend management module; and
e. a backend management module comprising a processor in communication with a non-volatile memory having a processor-readable medium thereon with a set of executable instruction configured to:
i. receive a parking space search query from at least one of the driver client devices;
ii. identify host client devices having a personal or a commercial parking space comprising a sensor array configured to provide information about vacancy of the parking space;
iii. connect at least one driver client device with a host client device; and
iv. receiving information from the sensor array indicating vacancy of the parking space.

2. The system of claim 1, wherein the sensor array comprises: an infrared (IR) sensor, a radar, an induction loop, a pressure sensor, a proximity sensor, a load cell, an ultrasound sensor, or a combination thereof in communication with a transceiver.

3. The system of claim 2, wherein the sensor array is configured to communicate with the driver client device and the host client device.

4. The system of claim 3, wherein the network is a cellular network, a local area network, a wide area network, a wireless network or a network comprising one or more of the foregoing.

5. The system of claim 4, wherein the driver client device comprises a transceiver and a processor in communication with a non-volatile memory having a processor-readable medium thereon with a set of executable instruction configured to:
a. establish communication with the backend management module;
b. provide preferred parking location;
c. establish communication with the host client device;
d. receive unique parking space identifier; and
e. communicate to the backend management module occupying and vacating the parking space

6. The system of claim 5, wherein the host client device comprises a transceiver and a processor in communication with a non-volatile memory having a processor-readable medium thereon with a set of executable instruction configured to:
a. establish communication with the backend management module;
b. establish communication with the sensor array;
c. authenticate the driver client device;
d. provide the driver client device with the unique identifier for the parking space; and
e. via communication with the sensor array, validate and communicate to the backend management module occupying and vacating the parking space.

7. A method for providing a user selected parking space, implementable in a system comprising: a plurality of driver client devices in communication with a communication network; a plurality of host client devices in communication with the communication network; a plurality of driver client databases in communication with the backend management module; a plurality of host client databases in communication with the backend management module; and a backend management module comprising a processor in communication with a non-volatile memory having a processor-readable medium thereon with a set of executable instruction configured to: receive a parking space search query from at least one of the driver client devices; identify host client devices having a personal or a commercial parking space comprising a sensor array configured to provide information about vacancy of the parking space; connect at least one driver client device with a host client device; and receiving information from the sensor array indicating vacancy of the parking space, the method comprising
a. the user, using the driver client device, communicating with the backend management module, selecting a preferred parking location;
b. the backend management module, communicating with the plurality of sensor arrays, each sensor array associated with a unique parking space and the host client device, identifying a vacant parking space closest to the user-selected location;
c. the backend module connecting the driver client device with the host client device associated with the vacant parking space closest to the user selected parking location; and
d. the host client device providing the driver client device with a unique identifier for the identified vacant parking space.

8. The method of claim 7, wherein the unique identifier comprises a location and means for authenticating the driver client device.

9. The method of claim 8, wherein the means for authenticating the driver client device comprise a personal identification number (PIN), a RFID identifier, a QR code, a barcode or a combination comprising one or more of the foregoing.

10. The method of claim 9, wherein the driver client device comprises a transceiver and a processor in communication with a non-volatile memory having a processor-readable medium thereon with a set of executable instruction configured to:
a. establish communication with the backend management module;
b. provide preferred parking location;
c. establish communication with the host client device;
d. receive unique parking space identifier; and
e. communicate to the backend management module occupying and vacating the parking space

11. The method of claim 10, wherein the host client device comprises a transceiver and a processor in communication with a non-volatile memory having a processor-readable medium thereon with a set of executable instruction configured to:
a. establish communication with the backend management module;
b. establish communication with the sensor array;
c. authenticate the driver client device;
d. provide the driver client device with the unique identifier for the parking space; and
e. via communication with the sensor array, validate and communicate to the backend management module occupying and vacating the parking space.

12. The method of claim 11, further comprising:
a. upon arriving at the user selected parking location, the driver client device communicating with the sensor array associated with the user selected parking space to authenticate the driver client device;
b. the driver client device transmitting to the host client device and the backend management module occupying the user selected parking space;
c. the sensor array, using the means for authenticating the driver client device, informing the host client device and the backend management module of the driver client device location and non-vacancy of the parking space associated with the sensor array.

13. The method of claim 12, further comprising the backend management server updating the driver client database and the host client database of the location of the driver client device, the occupancy status of the parking space and the expected occupation duration.

14. The method of claim 13, wherein the step of the backend management module, communicating with the plurality of sensor arrays, each sensor array associated with a unique parking space and the host client device, identifying a vacant parking space closest to the user-selected location, is preceded by a step of the backend management module retrieving all occupied parking spaces in the vicinity of the user selected parking space from the host client database and/or the driver client database.

15. The method of claim 14, the sensor array comprises: an infrared (IR) sensor, a radar, an induction loop, a pressure sensor, a proximity sensor, a load cell, an ultrasound sensor, or a combination thereof in communication with a transceiver.

16. The method of claim 15, wherein the network is a cellular network, a local area network, a wide area network, a wireless network or a network comprising one or more of the foregoing.
